(19) United States
(12) Patent Application Publication
(10) Pub. No.: US 2014/0283434 A1
(43) Pub. Date: Sep. 25, 2014

(54) FISH ATTRACTING FLASHER DEVICE

(71) Applicant: Dean Mark Teegarden, Boise, ID (US)

(72) Inventor: Dean Mark Teegarden, Boise, ID (US)

(21) Appl. No.: 14/222,336

(22) Filed: Mar. 21, 2014

Related U.S. Application Data
(60) Provisional application No. 61/803,994, filed on Mar. 21, 2013.

(51) Int. Cl. A01K 85/10; A01K 85/01

(52) U.S. Cl. CPC A01K 85/10; A01K 85/01
USPC 43/42.09; 43/42.19

(57) ABSTRACT

A fish attracting flasher having a body, and at least one simulant. The body having at least one deflector for deflecting water, a fore coupler for connecting with a fishing line, an aft coupler for connecting with a fishing line leader, and at least one simulant connector for connecting with at least one simulant or a fishing line leader. As the body is drawn through water, the fish attracting flasher simulates at least one predatory fish pursuing at least one bait fish.

### PRIORITY/CROSS-REFERENCE TO RELATED APPLICATIONS

This application claims the benefit of U.S. Provisional Application No. 61/803,994, filed Mar. 21, 2013, the disclosure of which is incorporated by reference.

### TECHNICAL FIELD

The disclosure generally relates to the field of outdoor recreation. Particular embodiments relate to fishing lures and accessories.

### BACKGROUND

Fish attracting flashers are fishing accessories used to mimic, adjacent a fishing lure, the action of a predatory fish chasing and feeding on a school of small bait fish, thereby attracting fish to the location of the fishing lure within the water column.

Fish attracting flashers are well known in the prior art. As explained in U.S. Pat. No. 2,891,344 to Hottowe, there are two common types of fish attracting flashers, namely “ . . . one of which may be classified as a spoon type and the other as a spinner type. The spoon type is generally rectangular in shape, sometimes rounded at the ends, and has its ends dished in opposite directions so that when the flasher is trolled at the proper speed and the lead is properly spaced therefrom, it will horizontally oscillate from side to side without turning over. By way of comparison, the spinner type is also generally rectangular in shape but is not dished or cupped like the spoon type. The spinner type is, however, usually bent oppositely at the ends somewhat like the letter S but with the forward part bent to a considerably less degree than the aft end. As a result, the spinner type constantly rotates with the aft end turning about a diameter approximating the length of the flasher and the front end turning about a lesser diameter.” The Hottowe patent discloses a third type of fish attracting flasher, a propeller that spins through the water.

### BRIEF DESCRIPTION OF THE DRAWINGS

FIG. 1 is a rear, upper, isometric view of a second exemplary fish attracting flasher.

FIG. 2 is a partial, top plan view of the fish attracting flasher of FIG. 1.

FIG. 3 is a partial, first end view of the fish attracting flasher of FIG. 1.

FIG. 4 is a partial, first side, lavational view of the fish attracting flasher of FIG. 1.

FIG. 5 is a partial, second end view of the fish attracting flasher of FIG. 1.

FIG. 6 is a partial, rear view of the fish attracting flasher of FIG. 1 shown in motion.

FIG. 7 is a first side, lavational view of the fish attracting flasher of FIG. 1.

FIG. 8 is a bottom plan view of the fish attracting flasher of FIG. 1.

FIG. 9 is a partial, side, lavational view of a third exemplary fish attracting flasher.

FIG. 10 is a side, lavational view of a first simulant.

FIG. 11 is an upper, side isometric view of a second simulant.

FIG. 12 is an upper isometric view of a simulant connector.

FIG. 13 is a side lavational view of the simulant connector of FIG. 12.

FIG. 14 is a side lavational view of a fourth exemplary fish attracting flasher.

FIG. 15 is an upper, rear isometric view of the fish attracting flasher of FIG. 14.

FIG. 16A is a first side, schematic illustration of the fish attracting flasher of

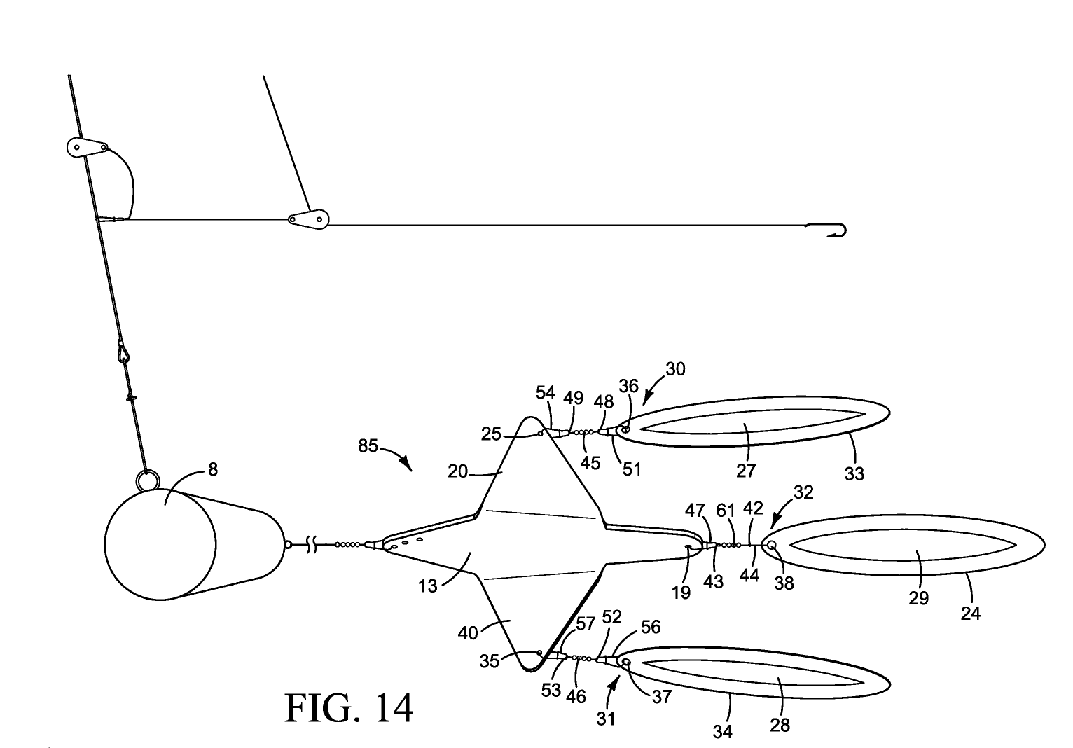

FIG. 14.

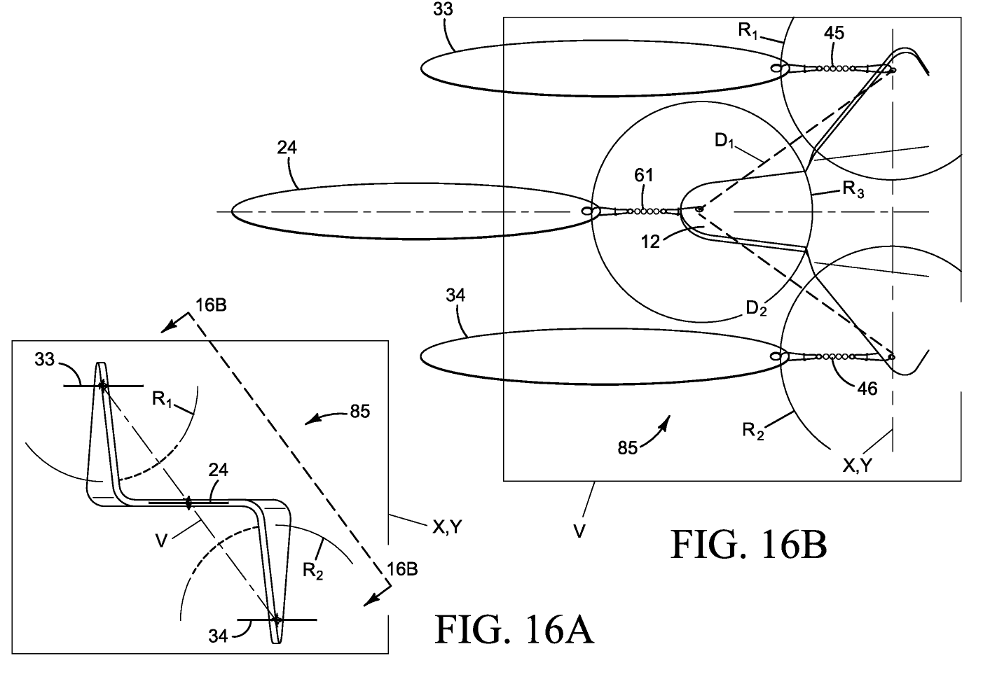

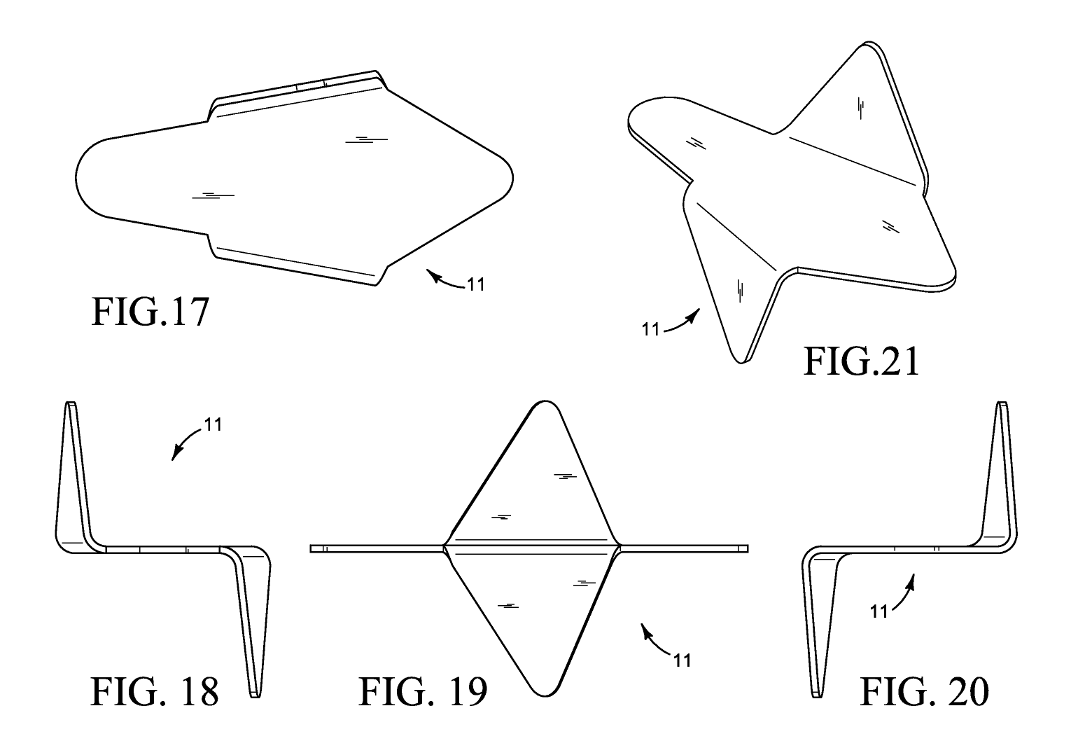

FIG. 16B is a second side, schematic illustration of the fish attracting flasher of FIG. 14.

FIG. 17 is a partial, top plan view of a fourth exemplary fish attracting flasher.

FIG. 18 is a partial, first end view of the fish attracting flasher of FIG. 17.

FIG. 19 is a partial, first side, lavational view of the fish attracting flasher of FIG. 17.

FIG. 20 is a partial, second end view of the fish attracting flasher of FIG. 17.

FIG. 21 is a rear, upper, isometric view of the fish attracting flasher of FIG. 17.

### DETAILED DESCRIPTION

The following description and the referenced drawings provide illustrative examples of that which the inventor regards as his invention. As such, the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

The use of “e.g.,” “etc,” “for instance,” “in example,” “for example,” and “or” and grammatically related terms indicates non-exclusive alternatives without limitation, unless the context clearly dictates otherwise. The use of “including” and grammatically related terms means “including, but not limited to,” unless the context clearly dictates otherwise. The use of the articles “a,” “an” and “the” are meant to be interpreted as referring to the singular as well as the plural, unless the context clearly dictates otherwise. Thus, for example, reference to “an indicia” includes two or more such indicia, and the like. The use of “optionally,” “alternatively,” and grammatically related terms means that the subsequently described element, event or circumstance may or may not be present/occur, and that the description includes instances where said element, event or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary” means “an example of” and is not intended to convey a meaning of an ideal or preferred embodiment. Words of approximation (e.g., “substantially,” “generally”), as used in context of the specification and figures, are intended to take on their ordinary and customary meanings which denote approximation, unless the context clearly dictates otherwise.

The use of “indicia,” means a marking, tinting, sign, color, symbol, shape, light reflective material, image, pattern, decal, or the like, visible on or within a component, including but not limited to indicia applied to and/or formed upon on the surface of a component, indicia embedded into a component, die cut decals bearing indicia, paint as indicia, and the like, or unless the context clearly dictates otherwise

The use of “bait fish indicia” means indicia used to simulate one or more bait fish, including indicia comprising an analogous representation of a bait fish, and indicia not comprising analogous representations of bait fish, unless the context clearly dictates otherwise.

The use of “predatory fish indicia” means indicia used to simulate one or more predatory fish, including indicia comprising an analogous representation of a predatory fish, and indicia not comprising analogous representations of predatory fish, unless the context clearly dictates otherwise.

The use of “fishing lure” means fishing bait having hooks for catching fish, including both live fishing bait as well as artificial fishing bait, unless the context clearly dictates otherwise.

The use of “fishing tackle connector” is used a generic term for commonly known fishing connectors, including but not limited to swivels, snap swivels, bead chain swivels, multi-connectors (e.g., tri-connectors, T-connectors, quad-connectors), clips, releasable connectors, snap fasteners, rings, lines, wires, combinations of the same, and the like, unless the context clearly dictates otherwise.

Disclosed herein are exemplary fish attracting flashers which can be used to mimic, adjacent an attached fishing lure, the action of a predatory fish chasing and feeding on a school of small bait fish, thereby attracting fish to the location of the fishing lure within the water column. Such fish attracting flashers have a body portion comprising at least one defector simulating a bait fish, and a simulant simulating a predatory fish.

A first exemplary fish attracting flasher has a body portion and at least one simulant. The body portion has bait fish indicia, and at least one deflector portion for deflecting water. The body portion has a fore coupler configured for connecting with a fishing line, and an aft coupler configured for connecting to a fishing line leader or an aft simulant. The at least one deflector comprises at least one simulant connector configured for connecting with the at least one simulant having predatory fish indicia. Wherein, as the body portion is drawn through water, the at least one deflector portion causes the body portion to rotate, and as the body portion rotates, the simulant rotates therewith to simulate at least one predatory fish (represented by the predatory fish indicia) pursuing at least one bait fish (represented by the bait fish indicia).

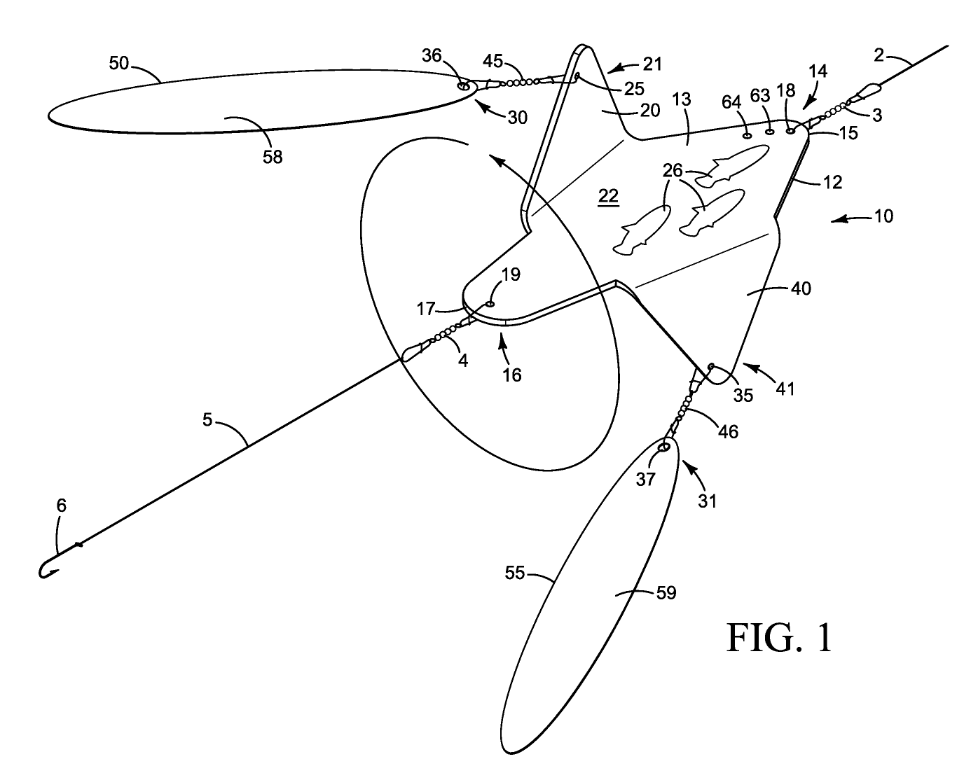

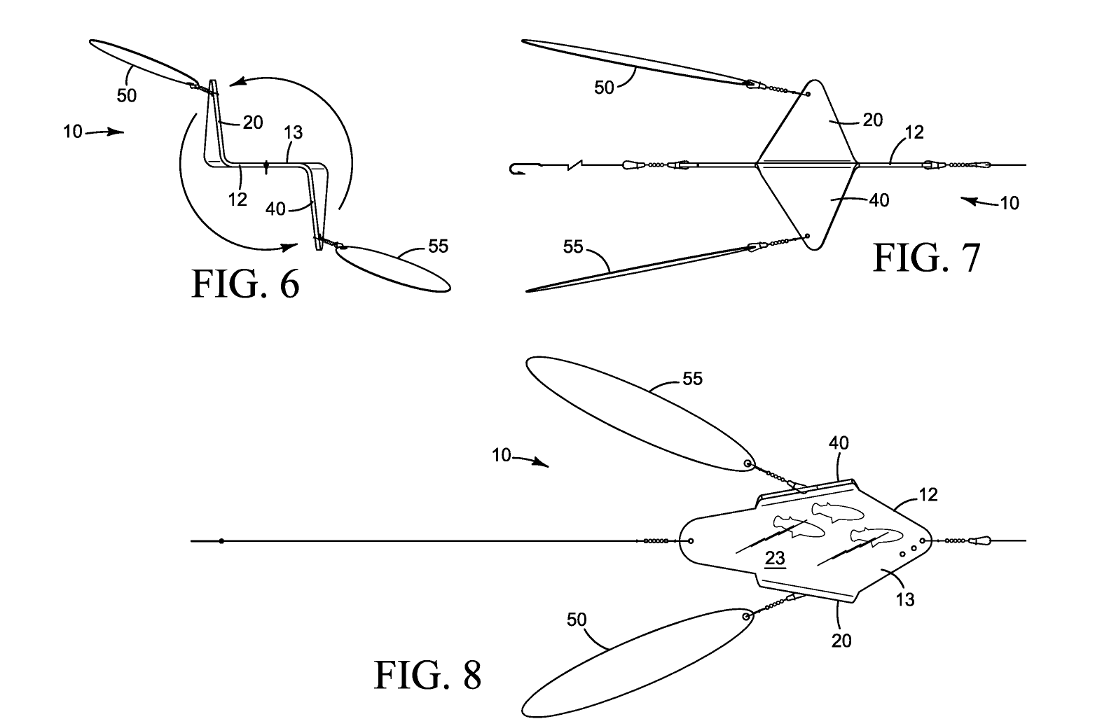

FIGS. 1 through 8 illustrate a second exemplary fish attracting flasher 10 configured for drawing through water. The fish attracting flasher 10 having a body portion 12 which has a center portion 13, a first deflector portion 20 and a second deflector portion 40. The fish attracting flasher 10 further having a first simulant 50 connected to the first deflector portion 20, and a second simulant 55 connected to the second deflector portion 40. When the body portion 12 is drawn through the water, the first deflector portion 20 and the second deflector portion 40 deflect water and cause the body portion 12, the first simulant 50, and the second simulant 55 to rotate relative to a body portion 12 rotational center point axis R.

The body portion 12 having a fore end 15 and an aft end 17, as well as a first side 22 and a second side 23. The fore end 15 comprises at least one fore mount 14 for connecting with a fishing line 2. The aft end 17 comprises at least one aft mount 16 configured for connecting with a fishing line 2 extending from a fishing pole or other fishing device, preferably via a fishing tackle connector 3. The aft mount 16 for connecting with a fishing line leader 5 which extends to a fishing lure 6 (e.g., a hook, a lure), preferably via a fishing tackle connector 4. In the second exemplary fish attracting flasher, the fore mount 14 comprises a fore coupler 18, and the aft mount 16 comprises an aft coupler 19. The fore coupler 18 comprising an orifice defined through the fore end 15 of the body portion 12, whereas the aft coupler 19 comprise an orifice defined through the aft end 17 of the body portion 12.

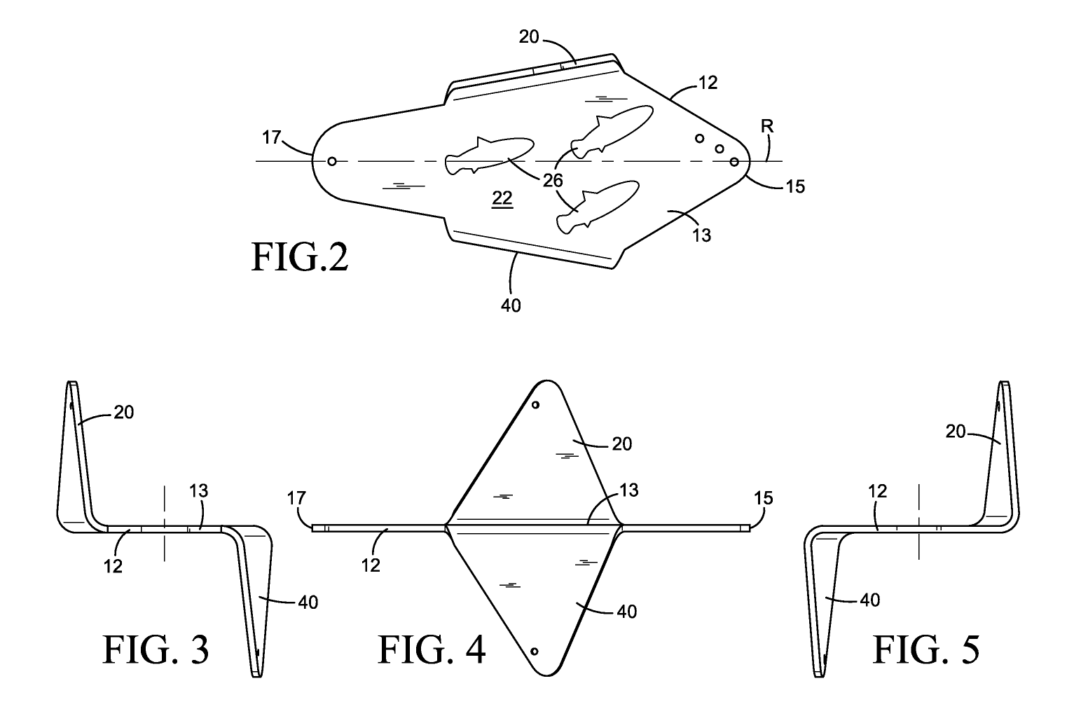

The axis defined between the aft end 17 and the fore end 15, more specifically the axis defined between the fore coupler and the aft coupler, defines a rotational center point axis R for the fish attracting flasher 10, as illustrated in FIG. 2. In the exemplary fish attracting flasher 10 illustrated particularly in FIGS. 1, 2 and 8, three fore couplers (fore coupler 18, fore coupler 63, fore coupler 64) are illustrated, and one aft coupler 19 is illustrated. A skilled artisan will be able to select the locations of the fore coupler and/or the aft coupler, as well as the number of the same, in a particular embodiment based on various considerations, including the intended use (e.g., season, type of fish) of the fish attracting flasher, the intended environment (e.g., water conditions, light conditions) within which the fish attracting flasher will be used, and the equipment and/or accessories with which the fish attracting flasher is intended to be used, among other considerations.

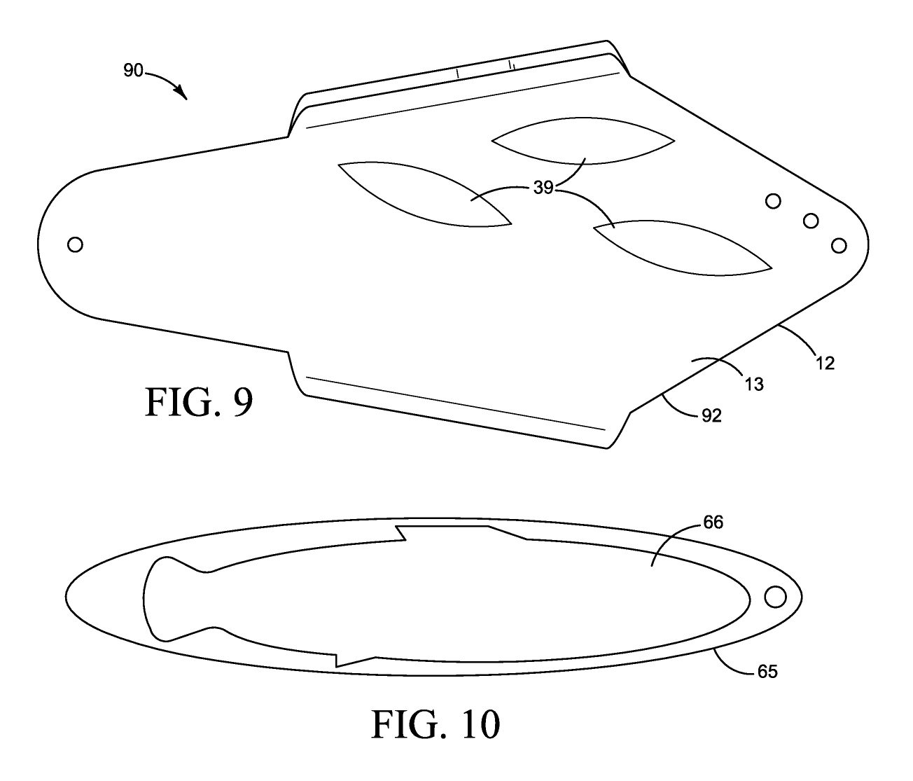

The body portion 12 preferably has at least one bait fish indicia 26. In other exemplary fish attracting flashers, no bait fish indicia may be provided. In FIGS. 1 through 8, illustrated are three bait fish indicia 26, the bait fish indicia 26 having a representational shape of bait fish. In other exemplary fish attracting flashers, for instance as can be seen in the body portion 92 of fish attracting flasher 90 illustrated in FIG. 9, the bait fish indicia 26 may have other shapes, including shapes not representational of the shape of bait fish, such as the oval shaped bait fish indicia 39 illustrated in FIG. 9.

The bait fish indicia 26 illustrated in the second exemplary fish attracting flasher 10 comprise a plurality of decals which have been adhered to the first side 22 surface of the body portion 12. As can be seen in FIG. 8, the body portion 12 is transparent, allowing the bait fish indicia 26 applied to the first side 22 surface to be viewed from the second side 23 surface. In other exemplary fish attracting flashers, the bait fish indicia can be otherwise present and/or attached to the body portion. For instance, the bait fish indicia could be integral to the body portion, could be painted onto the body portion, could be created with the indicia integral, etc.

It is preferred that the indicia on the body portion be located generally on one side or the other of the rotational center point axis R so that, as the body portion rotates as drawn through the water, the indicia will appear to “swim” in an alternating up and down motion, emulating a school of small fish darting up and down to avoid being eaten.

A skilled artisan will be able to select an appropriate size, shape, color, configuration, number, and method of applying to or within the body portion for the bait fish indicia in a particular embodiment based on various considerations, including the intended use (e.g., season, type of fish) of the fish attracting flasher, the intended environment (e.g., water conditions, light conditions) within which the fish attracting flasher will be used, and the equipment and/or accessories with which the fish attracting flasher is intended to be used, among other considerations.

As previously mentioned, the fish attracting flasher 10 has a first deflector portion 20 and a second deflector portion 40. The first deflector portion 20 and the second deflector portion 40 are deflected with respect to the plane of the body portion 12 so that, as drawn through the water, the fish attracting flasher 10 will rotate as a propeller. For instance, the first deflector portion 20 can extend at an obtuse angle away from the first side 22 of the body portion 12, and the second deflector portion 40 can extend at an obtuse angle away from the second side 23 of the body portion 12.

The body portion 12 further comprises at least one simulant connector for connecting with at least one simulant. The preferred simulant connector comprising a common fishing bead chain swivel having a releasable snap fastener connected to each end of the bead chain swivel. While such a simulant connector is preferred, a skilled artisan will be able to select an appropriate fishing tackle connector for use as a simulant connector in a particular embodiment based on various considerations, including the intended use (e.g., season, type of fish) of the fish attracting flasher, the intended environment (e.g., water conditions, light conditions) within which the fish attracting flasher will be used, and the equipment and/or accessories with which the fish attracting flasher is intended to be used, among other considerations.

In the exemplary fish attracting flasher 10 illustrated in FIGS. 1 through 8, the first deflector portion 20 comprises at least one first simulant coupler 25 for connecting with at least one first simulant 50, and the second deflector portion 40 comprises at least one second simulant coupler 35 for connecting with at least one second simulant 55. The first simulant 50 connects with the first simulant coupler 25 via a first simulant connector 45, whereas the second simulant 55 connects with the second simulant coupler 35 via a second simulant connector 46.

The preferred simulant connectors comprise one or more fishing tackle connectors. Utilization of a releasable connector is desirable to allow a user to quickly change the simulant to a different simulant without removing the flasher from the fishing line, while allowing complex freedom of movement of the simulants once they are attached. Exemplary simulant connectors may be flexible instead of rigid. While the exemplary fish attracting flashers illustrated in the Figures illustrate the use of a pair of simulants, in exemplary fish attracting flashers, there may one, two, three, or more simulants used.

The first simulant 50 comprises a first simulant mount 30, and the second simulant 55 comprises a second simulant mount 31. The first deflector portion 20 has a first deflector portion mount 21 configured for connecting with the first simulant mount 30 via a first simulant connector 45. The first simulant connector 45 comprises a swivel connector configured for connecting between the first simulant coupler 25 and the first simulant mount 30. The first simulant connector 45 has a first end 48 extending to a second end 49. The first end 48 comprising a first fastener 51, and the second end 49 comprising a second fastener 54. The first fastener 51 is configured for releasably connecting to the first simulant coupler 25, and the second fastener 54 is configured for releasably connecting to the first simulant mount 30. The second deflector portion 40 has a second deflector portion mount 41 configured for connecting with the first simulant mount 20 via a second simulant connector 46. The second simulant connector 46 comprises a swivel connector configured for connecting between the second simulant coupler 35 and the second simulant mount 31. The second simulant connector 46 has a first end 52 extending to a second end 53. The first end 52 comprising a first fastener 56, and the second end 53 comprising a second fastener 57. The first fastener 56 is configured for connecting to the second simulant coupler 35, and wherein the second fastener 57 is configured for connecting to the second simulant mount 31.

The first deflector portion mount 21 comprises a first simulant coupler 25 defined through the first deflector portion 20. The second deflector portion mount 41 comprises a second simulant coupler 35 defined through the second deflector portion 40. The first simulant mount 30 comprises a first simulant orifice 36 defined through the first simulant 50. The second simulant mount 31 comprises a second simulant orifice 37 defined through the second simulant 55.

It is preferred that the first simulant connector 45 and the second simulant connector 46 be located sufficiently fore of the aft mount 16 to decrease the possibility of the first simulant connector 45 and/or the second simulant connector 46 from becoming tangling with the fishing line leader 5. For instance, as described below in further detail with respect to FIGS. 16A, and 16B, the simulant connector is preferably is shorter than the lateral distance between the second simulant couplers and the aft mount. Likewise, it is preferred that the first and second simulant connectors be jointly shorter than the lateral distance between the first and second simulant connectors.

It is preferred that the first simulant 50 and second simulant 55 comprise a generally smooth, oval piece of clear, flexible plastic or vinyl film laminate which is die cut. Such simulants could be created through any known method, including but not limited to flexible film lamination, die cutting, hand cutting, molding, forming, and extrusion.

A generally smooth oval shape is preferred for the simulants so as to decrease the possibility that the first simulant 50 and/or the second simulant 55 will become entangled in the fishing line leader 5. While such a shape and material is preferred, a skilled artisan will be able to select an appropriate structure and material for the simulant(s) in a particular embodiment based on various considerations, including the intended use (e.g., season, type of fish) of the fish attracting flasher, the intended environment (e.g., water conditions, light conditions) within which the fish attracting flasher will be used, and the equipment and/or accessories with which the fish attracting flasher is intended to be used, among other considerations.

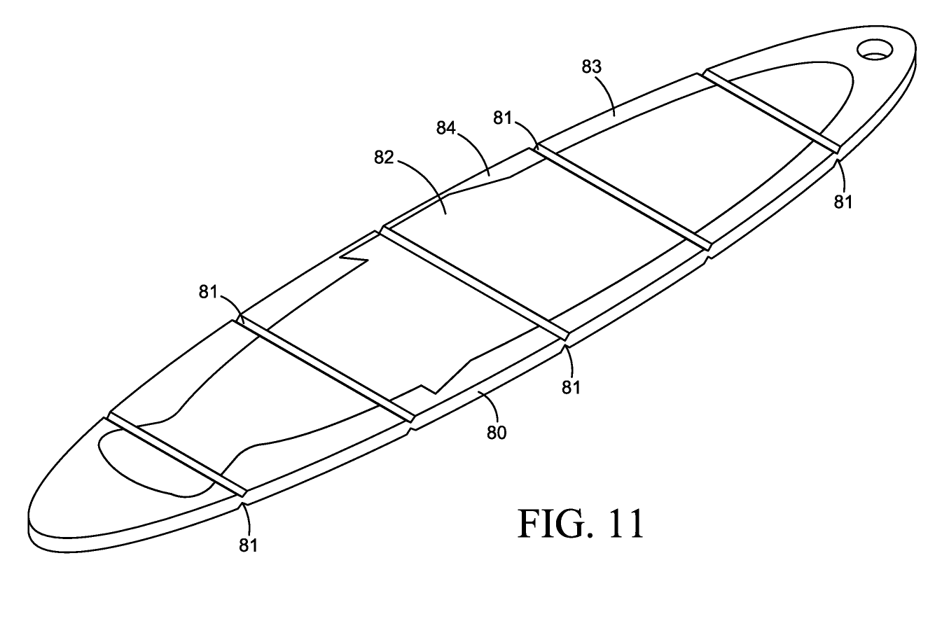

It is preferred that the first simulant 50 includes predatory fish indicia 58, and the second simulant 55 includes predatory fish indicia 59. In FIGS. 1 through 8, the predatory fish indicia 58 and the predatory fish indicia 59 generally cover the planar surface of the simulants. The predatory fish indicia 58 and predatory fish indicia 59 in the second exemplary fish attracting flasher 10 do not comprise analogous representations of suitable predatory fish, but instead comprise indicia which reflect light. In contrast, the predatory fish indicia 66 and predatory fish indicia 82 illustrated in FIGS. 10 and 11 (described in detail below), do comprise analogous representations of suitable predatory fish. A skilled artisan will be able to select an appropriate size, shape, color, configuration, and number for the predatory fish indicia in a particular embodiment based on various considerations, including the intended use (e.g., season, type of fish) of the fish attracting flasher, the intended environment (e.g., water conditions, light conditions) within which the fish attracting flasher will be used, and the equipment and/or accessories with which the fish attracting flasher is intended to be used, among other considerations.

As with respect to the bait fish indicia (described above), the predatory fish indicia could comprise a holographic Mylar decal cut (e.g. die cut) in the shape of a predatory fish, wherein the Mylar decal is adhered to the simulant. Alternatively, the simulant could be created with the indicia integral. A skilled artisan will be able to select an appropriate size, shape, color, configuration, number, and method of applying to or within the body portion for the predatory fish indicia in a particular embodiment based on various considerations, including the intended use (e.g., season, type of fish) of the fish attracting flasher, the intended environment (e.g., water conditions, light conditions) within which the fish attracting flasher will be used, and the equipment and/or accessories with which the fish attracting flasher is intended to be used, among other considerations.

The simulants, when more than one simulant is used, can be of differing relative sizes. For instance a first simulant could be 50-65% larger than a second simulant. In other exemplary fish attracting flashers, the simulants could be the exact same size.

An exemplary fish attracting flasher can comprise one or more weighted portions located on one of the sides of the rotational center point axis, including, but not limited to, being attached to the simulant connector, attached on one of the simulants, and being attached on the body portion itself. The purpose of the weighted portion is to shift the center of gravity, thereby creating an irregular rotation of the body portion when drawn through the water, causing it to rotate slower as it lifts the weighted portion to its apex, and then rotating faster as the weighted portion falls away from its apex. This can cause a first one of simulants to quickly revolve around the other simulant (or vice versa), thereby simulating the motion of that one of the two simulants is darting quickly towards the body portion to catch the bait fish represented by the indicia on the body portion.

In exemplary fish attracting flashers, as the simulants are drawn through the water they can be configured to bend or flex to deform to match the rotational path of the body portion, thereby presenting a natural fish profile and silhouette from all viewing angles. Referring now to FIG. 11, illustrated is another exemplary simulant 80 comprising at least two panels (first panel 83, and second panel 84) hingedly connected at a hinge portion 81 to one another. The simulant 80 further comprising indicia 82.

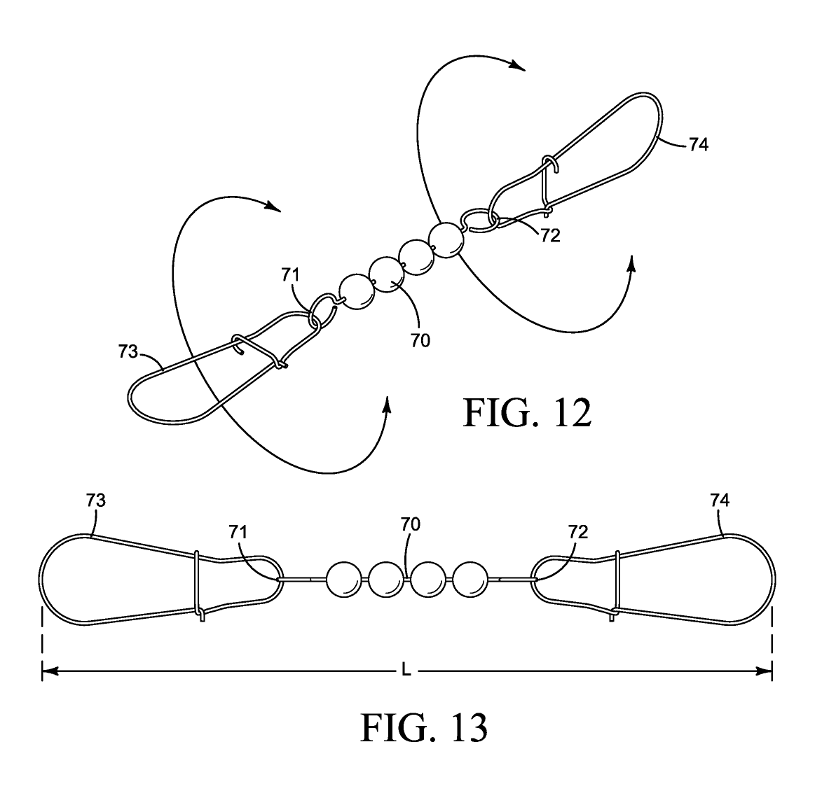

Referring now to FIGS. 12 and 13, illustrated is one exemplary simulant connector 70. The simulant connector 70 comprises a swivel connector. The simulant connector 70 has a first end 71 extending to a second end 72. The first end 71 comprising a first fastener 73. The second end 72 comprising a second fastener 74. Preferably the fasteners are releasable. The simulant connector 70 having a length L defined as generally the distance between the end of the first fastener 73 and the end of the second fastener 74. Such a connector is a common fishing tackle connector, and is merely one example of a possible simulant connector. A skilled artisan will be able to select a simulant connector and/or fishing tackle connector for use in a particular embodiment based on various considerations, including the intended use (e.g., season, type of fish) of the fish attracting flasher, the intended environment (e.g., water conditions, light conditions) within which the fish attracting flasher will be used, and the equipment and/or accessories with which the fish attracting flasher is intended to be used, among other considerations.

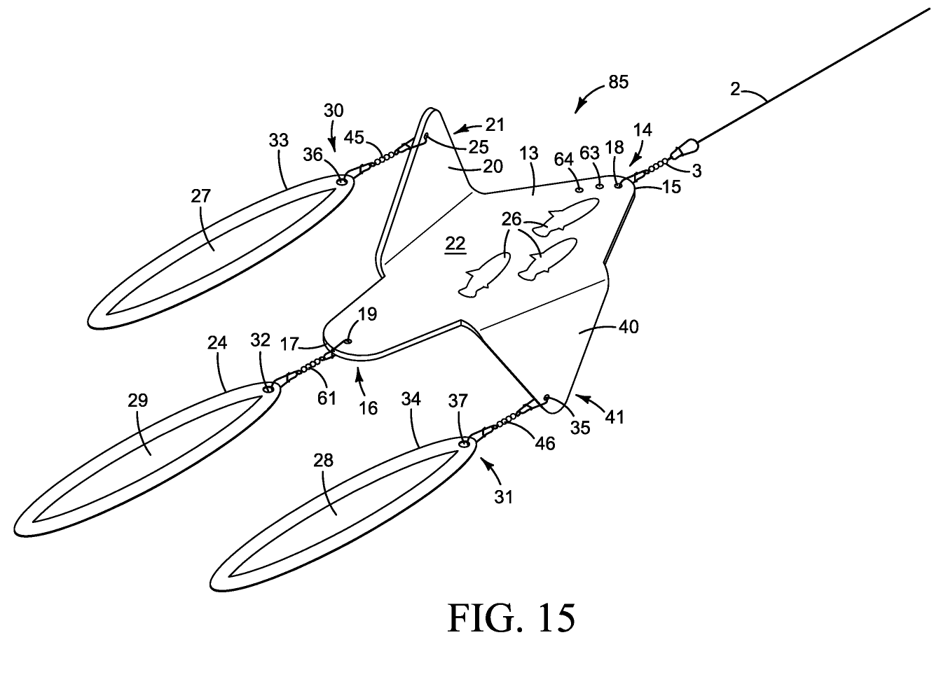

A third exemplary fish attracting flasher 85 is illustrated in FIGS. 14, 15, 16A, and 16B where the fish attracting flasher 85 is illustrated as part of a downrigger 8. The third exemplary fish attracting flasher 85 is similar to the second exemplary fish attracting flasher 10 illustrated in FIGS. 1 through 8 and described above, except as detailed below. In the exemplary fish attracting flasher 10 illustrated in FIGS. 1 through 8, the aft mount 16 is configured for connecting with at least one fishing line leader 5. In the exemplary fish attracting flasher 85 illustrated in FIGS. 14, 15, 16A, and 16B, the aft mount 16 is configured for connecting with a third simulant 24 via a third simulant connector 61.

The aft mount 16 comprises an aft coupler 19 configured for connecting the body portion 12 to the third simulant. The aft coupler 19 comprises a third simulant connector instead of the fishing line leader illustrated with respect to the second exemplary fishing line leader. The aft mount 16 has an aft coupler 19 comprising an orifice defined through the aft mount 16. The third simulant 24 has a third simulant mount 32. The third simulant mount 32 comprises a third simulant orifice 38 defined through the third simulant 24. The third simulant connector 61 has a first end 42 extending to a second end 43. The first end 42 has a first fastener 44, whereas the second end 43 has a second fastener 47. The first fastener 44 is configured for connecting to the third simulant mount 32, and the second fastener 47 is configured for connecting to the aft coupler 19.

Referring now to FIGS. 16A and 16B, to decrease the possibility that the first simulant 33 and/or the second simulant 34 will become entangled in one another, or in the third simulant 24, it is preferred that the simulants be spaced apart. As illustrated in these figures, the first simulant connector 45 has a first length defined as generally the distance between the end of the first fastener 51 and the end of the second fastener 54. The first length defining a radius R₁. The second simulant connector 46 has a second length defined as generally the distance between the end of the first fastener 56 and the end of the second fastener 57. The second length defining a radius R₂. The third simulant connector 61 has a third length defined as generally the distance between the end of the first fastener 42 and the end of the second fastener 47. The third length defining a radius R₃. By configuring the fish attracting flasher 85 so that the distance D between the first simulant coupler 25 and the aft coupler 19 is greater than the sum of the first length and the third length, and/or the distance D between the first simulant connector 45 and the second simulant connector 46 is greater than the sum of the first length and the second length, the possibility that the simulants can be prevented from entanglement.

FIGS. 17, 18, 19, 20 and 21 illustrate a fourth exemplary fish attracting flasher 11.

A fifth exemplary fish attracting flasher has a body portion, at least one simulant, and at least one simulant connector. The body portion has bait fish indicia, and at least one deflector portion for deflecting water. The body portion has a fore coupler configured for connecting with a fishing line, and an aft coupler configured for connecting to a fishing line leader. The at least one simulant connector extends away from the body portion at an obtuse angle, and is configured for connecting with the at least one simulant having predatory fish indicia. Wherein, as the body portion is drawn through water, the at least one deflector portion causes the body portion to rotate, and as the body portion rotates, the simulant rotates therewith to simulate at least one predatory fish (represented by the predatory fish indicia) pursuing at least one bait fish (represented by the bait fish indicia).

A sixth exemplary fish attracting flasher has a body portion, a first simulant, a second simulant, a first simulant connector, and a second simulant connector. The body portion has bait fish indicia, and at least one deflector portion for deflecting water. The body portion has a fore coupler configured for connecting with a fishing line, and an aft coupler configured for connecting to a fishing line leader. The first simulant connector extends away from a first side of the body portion at an obtuse angle, and is configured for connecting with the first simulant. The second simulant connector extends away from a second side of the body portion at an obtuse angle, and is configured for connecting with the second simulant. The first and second simulants having predatory fish indicia. Wherein, as the body portion is drawn through water, the at least one deflector portion causes the body portion to rotate, and as the body portion rotates, the first and second simulants rotate therewith to simulate at least one predatory fish (represented by the predatory fish indicia) pursuing at least one bait fish (represented by the bait fish indicia).

A seventh exemplary fish attracting flasher has a body portion, a first simulant and a second simulant. The body portion has bait fish indicia, a first deflector portion for deflecting water, and a second deflector portion for deflecting water. The body portion has a fore coupler configured for connecting with a fishing line, and an aft coupler configured for connecting to a fishing line leader or third simulant. The first deflector portion comprises a first simulant connector configured for connecting with the first simulant. The second deflector portion comprises a second simulant connector configured for connecting with the first simulant. The first and second simulants having predatory fish indicia. Wherein, as the body portion is drawn through water, the deflector portions causes the body portion to rotate, and as the body portion rotates, the simulants rotate therewith to simulate at least one predatory fish (represented by the predatory fish indicia) pursuing at least one bait fish (represented by the bait fish indicia).

In a first exemplary fish attracting flasher system; the system comprises a body portion, at least one first simulant, and at least one alternate simulant. The body portion has bait fish indicia, and at least one deflector portion for deflecting water. The body portion has a fore coupler configured for connecting with a fishing line, and an aft coupler configured for connecting to a fishing line leader or other fishing component. The at least one deflector comprises at least one simulant connector configured for connecting with the at least one first simulant having predatory fish indicia (the “first” indicia). Wherein, as the body portion is drawn through water, the at least one deflector portion causes the body portion to rotate, and as the body portion rotates, the simulant attached thereto rotates therewith to simulate at least one predatory fish (represented by the predatory fish indicia) pursuing at least one bait fish (represented by the bait fish indicia).

The at least one alternate simulant comprises alternate indicia that is different from the first indicia on the first simulant. Likewise, the first exemplary fish attracting flasher system could further comprise a second simulant and at least one alternate second simulant. The at least one alternate second simulant could comprise alternate indicia that is different from the first indicia on the second simulant. For instance, the alternate indicia could be a different size, shape, configuration, color, reflectiveness, etc.

In use, a user can disconnect the first simulant from the first simulant connector, and replace it with the alternate first simulant. Likewise, the user can disconnect the second simulant from the second simulant connector and replace it with the alternate second simulant. In the Figures, the simulants/indicia of FIG. 1 could be a “first simulant”, and the simulants/indicial of FIG. 10 could be an “alternate simulant.”

Any suitable structure and/or material can be used for the components of an exemplary fish attracting flasher, and a skilled artisan will be able to select an appropriate structure and material for the fish attracting flasher in a particular embodiment based on various considerations, including the intended use (e.g., season, type of fish) of the fish attracting flasher, the intended environment (e.g., water conditions, light conditions) within which the fish attracting flasher will be used, and the equipment and/or accessories with which the fish attracting flasher is intended to be used, among other considerations.

It is noted that all structure and features of the various described and illustrated embodiments can be combined in any suitable configuration for inclusion in a fish attracting flasher according to a particular embodiment. For example, a fish attracting flasher according a particular embodiment can include neither, one, or both of a fishing line leader and the third simulant described above.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. A fish attracting flasher, comprising a body and at least one simulant,
wherein said body comprises: at least one deflector for deflecting water, bait fish indicia, said bait fish indicia comprising at least one analogous representation of at least one bait fish, a fore mount for connecting with a fishing line, an aft mount for connecting with a fishing line leader, and at least one simulant connector for connecting with said at least one simulant;
wherein said at least one simulant comprises predatory fish indicia, said predatory fish indicia comprising at least one analogous representation of at least one predatory fish,
wherein as the body is drawn through water, said body rotates, and
wherein as said body rotates, said simulant rotates therewith to simulate at least one predatory fish pursuing at least one bait fish.

2. A fish attracting flasher for drawing through water, said fish attracting flasher comprising: a body portion, a first simulant, and a second simulant,
wherein said body portion comprises a center portion, a first deflector portion and a second deflector portion, said body portion having a fore end and an aft end, said body portion having a first side and a second side, wherein said fore end comprises at least one fore mount for connecting with a fishing line, and wherein said aft end comprises at least one aft mount, said first deflector portion extending at an obtuse angle away from the first side of the body portion, said first deflector portion comprising at least one first simulant coupler for connecting with at least one first simulant, and said second deflector portion extending at an obtuse angle away from the second side of the body portion, said second deflector portion comprising at least one second simulant coupler for connecting with at least one second simulant;
wherein said first simulant connects with said first simulant coupler via a first simulant connector;
wherein said second simulant connects with said second simulant coupler via a second simulant connector; and
wherein when said body portion is drawn through said water, said first deflector portion and said second deflector portion deflects said water and cause the body portion, the first simulant, and the second simulant to rotate relative to a body portion rotational axis.

3. The fish attracting flasher of claim 2, wherein said first simulant comprises a first simulant mount, and wherein said second simulant comprises a second simulant mount.

4. The fish attracting flasher of claim 3, wherein said first simulant connector comprises a first simulant connector configured for connecting between said first simulant coupler and said first simulant mount.

5. The fish attracting flasher of claim 4, wherein said first simulant connector has a first end extending to a second end, said first end comprising a first fastener, said second end comprising a second fastener, wherein said first fastener is configured for releasably connecting to said first simulant coupler, and wherein said second fastener is configured for releasably connecting to said first simulant mount.

6. The fish attracting flasher of claim 3, wherein said second simulant connector comprises a second simulant connector configured for connecting between said second simulant coupler and said second simulant mount.

7. The fish attracting flasher of claim 6, wherein said second simulant connector has a first end extending to a second end, said first end comprising a first fastener, said second end comprising a second fastener, wherein said first fastener is configured for connecting to said second simulant coupler, and wherein said second fastener is configured for connecting to said second simulant mount.

8. The fish attracting flasher of claim 3, wherein said first simulant mount comprises a first simulant coupler defined through said first deflector portion, and wherein said second simulant mount comprises a second simulant coupler defined through said second deflector portion.

9. The fish attracting flasher of claim 2, wherein said first simulant coupler comprises an orifice defined through said first simulant, and wherein said second simulant coupler comprises a second orifice defined through said second simulant.

10. The fish attracting flasher of claim 2, wherein said at least one aft mount is configured for connecting with at least one fishing line leader.

11. The fish attracting flasher of claim 2, wherein said at least one aft mount is configured for connecting with a third simulant via a third simulant connector, said at least one aft mount comprising an aft coupler, said aft coupler comprising a first orifice defined through said aft mount, said third simulant comprising a third simulant mount, said third simulant mount comprising a second orifice defined through said third simulant, said third simulant connector has a first end extending to a second end, said first end comprising a first fastener, said second end comprising a second fastener, wherein said first fastener is configured for connecting to said third simulant mount, and wherein said second fastener is configured for connecting to said aft coupler.

12. The fish attracting flasher of claim 11, wherein said first simulant connector has a first length, wherein said third simulant connector has a third length, and wherein the distance between the first simulant coupler and the third simulant mount is greater than the sum of the first length and the third length.

13. The fish attracting flasher of claim 2, wherein said first simulant connector has a first length, wherein said second simulant connector has a second length, and wherein the distance between the first simulant coupler and the second simulant coupler is greater than the sum of the first length and the second length.

14. The fish attracting flasher of claim 2, wherein said body portion comprises indicia on.

15. The fish attracting flasher of claim 14 wherein said indicia is reflective.

16. The fish attracting flasher of claim 2, wherein said first simulant comprises indicia, and said second simulant comprises indicia.

17. The fish attracting flasher of claim 16, wherein said indicia is reflective.

18. The fish attracting flasher of claim 16, further comprising at least one alternate first simulant comprising different indicia than the first simulant, wherein a user can disconnect the first simulant from the first simulant connector and replace it with the alternate first simulant.

19. The fish attracting flasher of claim 18, further comprising at least one alternate second simulant comprising different indicia than the second simulant, wherein a user can disconnect the second simulant from the second simulant connector and replace it with the alternate second simulant.

20. A fish attracting flasher for drawing through water, said fish attracting flasher comprising:
a body portion; a first simulant; and a second simulant,
wherein said body portion comprises a center portion, a first deflector portion and a second deflector portion, said body portion having a fore end and an aft end, said body portion having a first side and a second side, wherein said fore end comprises at least one fore mount for connecting with a fishing line, and wherein said aft end comprises at least one aft mount, said first deflector portion extending at an obtuse angle away from the first side of the body portion, said first deflector portion comprising at least one first simulant coupler for connecting with at least one first simulant, and said second deflector portion extending at an obtuse angle away from the second side of the body portion, said second deflector portion comprising at least one second simulant coupler for connecting with at least one second simulant;
wherein said first simulant connects with said first simulant coupler via a first simulant connector, wherein said first simulant comprises a first simulant mount, wherein said first simulant connector is configured for connecting between said first simulant coupler and said first simulant mount, wherein said first simulant connector has a first end extending to a second end, said first end comprising a first fastener, said second end comprising a second fastener, wherein said first fastener is configured for releasably connecting to said first simulant coupler, and wherein said second fastener is configured for releasably connecting to said first simulant mount;
wherein said second simulant connects with said second simulant coupler via a second simulant connector, wherein said second simulant comprises a second simulant mount, wherein said second simulant connector is configured for connecting between said second simulant coupler and said second simulant mount, and wherein said second simulant connector has a first end extending to a second end, said first end comprising a first fastener, said second end comprising a second fastener, wherein said first fastener is configured for connecting to said second simulant coupler, and wherein said second fastener is configured for connecting to said second simulant mount;
wherein when said body is drawn through said water, said first deflector portion and said second deflector portion deflects said water and cause the body portion, the first simulant, and the second simulant to rotate relative to a body portion rotational axis; and
wherein said first simulant connector has a first length, wherein said second simulant connector has a second length, and wherein the distance between the first simulant coupler and the second simulant coupler is greater than the sum of the first length and the second length.
